(19) United States
(12) Patent Application Publication
(10) Pub. No.: US 2026/0247265 A1
(43) Pub. Date: Aug. 20, 2026

(54) INTERWORKING EXTENSION FOR INTERNET SPEED

(71) Applicant: MEDIATEK INC., Hsinchu City (TW)

(72) Inventors: Vishal Bhargava, Noida (IN); Shivam Ahuja, Noida (IN); Abhijeet Singh Katiyar, Noida (IN); Rahul Mahajan, Noida (IN)

(73) Assignee: MEDIATEK INC., Hsinchu City (TW)

(21) Appl. No.: 19/172,670

(22) Filed: Apr. 8, 2025

(30) Foreign Application Priority Data
Feb. 20, 2025 (IN) 202521014521

(51) Int. Cl. H04W 48/16; H04W 76/10

(52) U.S. Cl. CPC H04W 48/16; H04W 76/10

(57) ABSTRACT

A method for an STA to connect with an access point (AP) of a plurality of APs includes: the STA performing discovery of the plurality of APs via frame exchange between the STA and the plurality of APs; the STA determining whether a received frame from each of the plurality of APs comprises an interworking element, wherein the interworking element includes an extension; when a received frame includes an interworking element including an extension, accessing the information in the extension; comparing the information in the extension of each received frame to determine a candidate AP from the plurality of APs; and initiating connection with the candidate AP to access a network of the candidate AP.

### BACKGROUND

The invention is related to a client device performing discovery of access points in order to determine a best network, and more particularly, to an extension for an interworking element which enables a client device to make better informed decisions when determining to connect to a network.

When a client device (STA) wishes to join a network, the STA searches for access points (APs) via an active scanning technique such as sending a probe request to the APs, or via a passive scanning technique such as listening for beacons sent from the APs. The APs have a Service Set Identifier (SSID) which is a unique name that allows the client device to distinguish between different networks. Previously, a STA would only be provided with basic security information of the network/AP.

Interworking is a protocol enhancement which was introduced in the IEEE 802.11U specification, and enables a STA to learn about a network before determining to connect. By including an interworking information element (IE) in beacon frames or probe response frames sent by the APs, a STA can use the information therein to select a best network from among different APs. When a frame includes the interworking IE, it can be known that the device supports 802.11U.

Refer to FIG. 1, which illustrates the interworking information element 100. As shown in the diagram, the element contains the following fields: Element ID, Length, Access Network Options, Venue Information, and HESSID. The diagram also shows the number of octets in each field. The Access Network Options indicates whether the available network is free, private or public, for a personal device, for emergencies only etc. The Venue Information is an optional field, and may indicate the class of venue (e.g. industrial, residential, vehicular, outdoor etc.) The HESSID is a Homogeneous Service Set Identifier, and is also an optional field. This field indicates a group of basic service sets which provide access to the same external networks, and comprises a globally unique ID which can be used in concert with the SSID to identify a specific service provider network.

As detailed above, when an AP supports 802.11U, the interworking IE is contained in beacons or probe response frames sent by the AP.

Currently, there is no technique for advertising Internet speed offered by an AP. It is also not currently possible to know network latency before a client device determines to connect with the network. When a STA roams between APs within a network, the STA can use a received signal strength indicator (RSSI) of the APs in order to decide which AP to roam to, but other aspects of the network are not part of the decision-making process. If more information could be included in the interworking IE, a STA could leverage this information for better network selection.

### SUMMARY

This in mind, the invention aims to provide an extension to the interworking information element. By directly including information regarding network latency and connectivity speed in the interworking information element, this information can be advertised to a client device. The client device can use the information when deciding which network to connect to, and no extra frames need to be sent between the client device and the AP.

According to an exemplary embodiment of the present invention, a method for an STA to connect with an access point (AP) of a plurality of APs comprises: the STA performing discovery of the plurality of APs via frame exchange between the STA and the plurality of APs; the STA determining whether a received frame from each of the plurality of APs comprises an interworking element, wherein the interworking element includes an extension; when a received frame comprises an interworking element including an extension, accessing the information in the extension; comparing the information in the extension of each received frame to determine a candidate AP from the plurality of APs; and initiating connection with said AP to access a network of said AP.

The frame exchange comprises: the STA sending a probe request frame to each of the plurality of APs, and receiving a probe response frame from each of the plurality of APs; or listening for a beacon frame from each of the plurality of APs

The information in the extension comprises network latency and connectivity speed, wherein the network latency information field comprises a value of a plurality of first values, wherein the plurality of first values are respectively mapped to a plurality of network latency ranges; and the connectivity speed field comprises a value of a plurality of second values, wherein the plurality of second values are respectively mapped to a plurality of connectivity speed ranges.

The decision to connect with the AP can be made automatically by the STA according to profile settings, or according to a user decision, wherein the network latency and connectivity speed is displayed to the user.

In accordance with another exemplary embodiment of the present invention, an extension for an interworking element in a frame sent from an access point (AP) to a client device (STA) comprises: a network latency information field containing information regarding latency and a connectivity speed of the AP WAN Interface (ISP Connectivity). The frame is a beacon frame or a probe response frame sent by the AP to the STA. The network latency field comprises a value of a plurality of first values, wherein the plurality of first values are respectively mapped to a plurality of network latency ranges; and the connectivity speed field comprises a value of a plurality of second values, wherein the plurality of second values are respectively mapped to a plurality of connectivity speed ranges. The extension has a length of one octet, the network latency field comprises four bits and the connectivity speed comprises four bits.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an interworking information element (IE) as defined in the 802.11U specification.

FIG. 2 is a diagram of an extension to the interworking IE shown in FIG. 1 according to an exemplary embodiment of the present invention.

FIG. 3 is a diagram of a client device roaming between two APs using the information contained in the extension illustrated in FIG. 2 in order to make the roaming decision.

### DETAILED DESCRIPTION

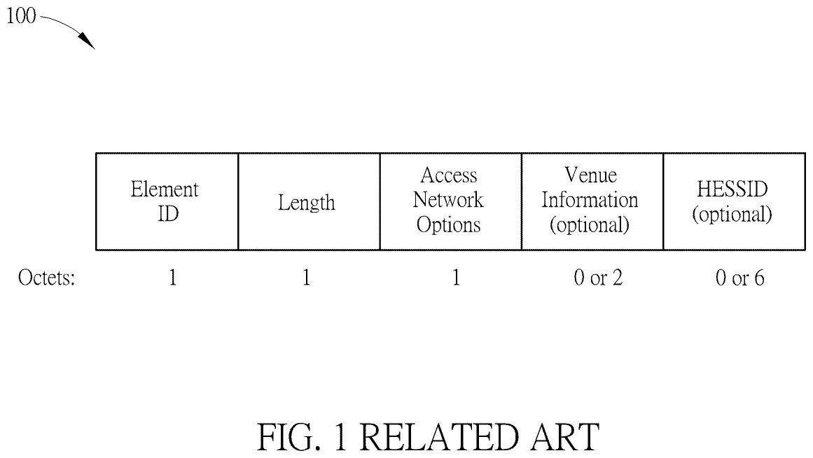

It is an objective of the present invention to provide an extension to the interworking IE illustrated in FIG. 1, by adding a Network Connectivity Status field. This extra field defines network-related information which aids a client device when deciding which network to initially connect to or when performing roaming decisions.

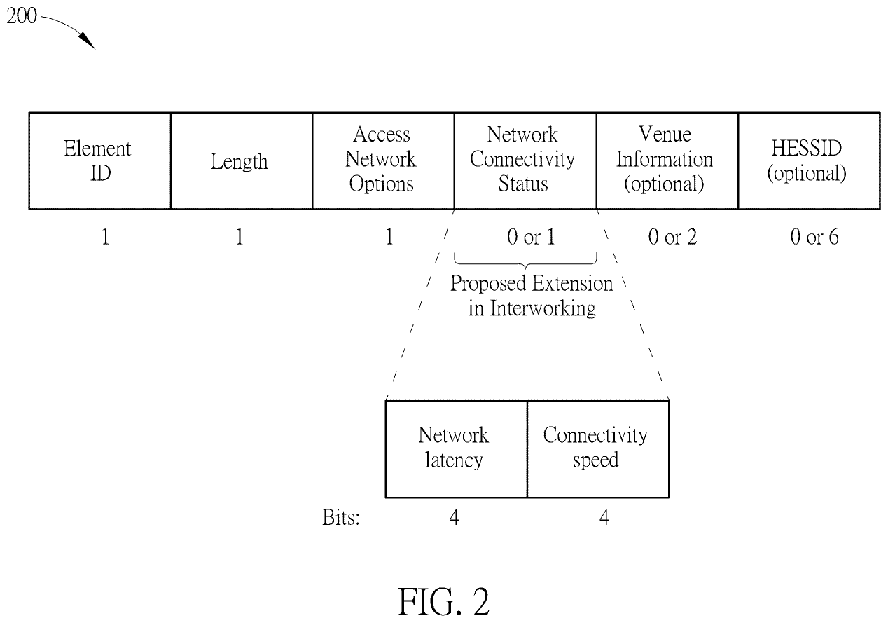

Refer to FIG. 2, which illustrates the proposed extension to the interworking IE shown in FIG. 1. As shown in the diagram, a Network Connectivity Status field is added between the Access Network Options and Venue Information fields. The Network Connectivity Status field is a 1-byte field (length=1 octet) and is divided into two parts, each comprising four bits. A first four bits provide information related to network latency of the AP, and the last four bits provide information related to the connectivity speed of the network. Note that the division of the Network Connectivity Status as shown in FIG. 2 is merely an example and there is the possibility for more network-related information to be included, i.e. the extension is not limited to the two fields shown in FIG. 2.

The Network Connectivity Status field can be set to 0 or 1. When the field is set to 1, this indicates that the AP sending the frame wants to advertise that a client device can access latency and connectivity speed information of the AP. When the AP does not want to advertise this information, the field is set to 0. Thus, this interworking extension is optional and backwards compatible, and no harm will be caused to devices which do not support providing the information.

The information included in the Network Connectivity Status can be determined by the AP in a number of ways. For the network latency information, the AP can ping a server with a network packet in order to measure latency and response time. For the connectivity speed, the AP can monitor current load and determine available connectivity speed according to the available bandwidth as well as any other STAs within the network. These techniques are already well-known in the art and the invention is not limited to these specific techniques. No matter how the information is obtained, the interworking extension provides a means of making this information available to a client device, and can be used by the client device when determining a best network.

The AP can set a predetermined number of ranges for both network latency and connectivity speed, and define a particular value corresponding to a particular range which will be included in the interworking extension as a means of illustrating the network-related information. This is one example of how the information within the Network Connectivity Status field can be displayed.

Table 1, shown below, is a table mapping a plurality of different values to a plurality of network latency ranges. Table 2, shown below, is a table mapping a plurality of different values to a plurality of connectivity speeds. The examples given below are merely illustrative and an AP can define the latency and connectivity speed information in a number of different ways. The following information is set by the Internet provider.

TABLE 1

| Network | Actual | |
|---|---|---|
| latency | latency | |
| 0 | Reserved | |
| 1 | 0-10 | ms |
| 2 | 10-20 | ms |
| 3 | 20-30 | ms |
| 4 | 30-40 | ms |
| 5 | 40-50 | ms |
| 6 | 50-60 | ms |

| | |
|---|---|
| . . . | . . . |

TABLE 2

| Connectivity | Actual | |
|---|---|---|
| speed | speed range | |
| 0 | No Internet/ | |
| | Backbone | |
| 1 | 0-5 | Mbps |
| 2 | 6-40 | Mbps |
| 3 | 41-100 | Mbps |
| 1 | 101-500 | Mbps |
| 5 | 501 Mbps-1 Gbps | |
| 6 | 1-5 | Gps |

| | |
|---|---|
| . . . | . . . |

By providing the above information in the interworking extension, a client device has more information regarding a specific AP. During an initial connection to a network or when a client device roams between different APs, the client device can determine a best AP for network connection by comparing this information for different APs. This decision can be made automatically according to settings; for example, a default setting could be to connect to the AP with the lowest network latency and/or the highest connectivity speed. Alternatively, the information contained within the interworking extension can be advertised to the client device such that a user can directly make the decision. The information can be presented to the user in a number of different ways—for example, the user can access available wireless networks via a settings page of the client device, and can select a specific AP in order to view the network-related information. In another embodiment, the user can manually set criteria for determining an AP for network connection. For example, the user may set network latency as the most important criterion when determining which AP to connect with, such that the STA/client device will automatically connect to an AP having the lowest network latency.

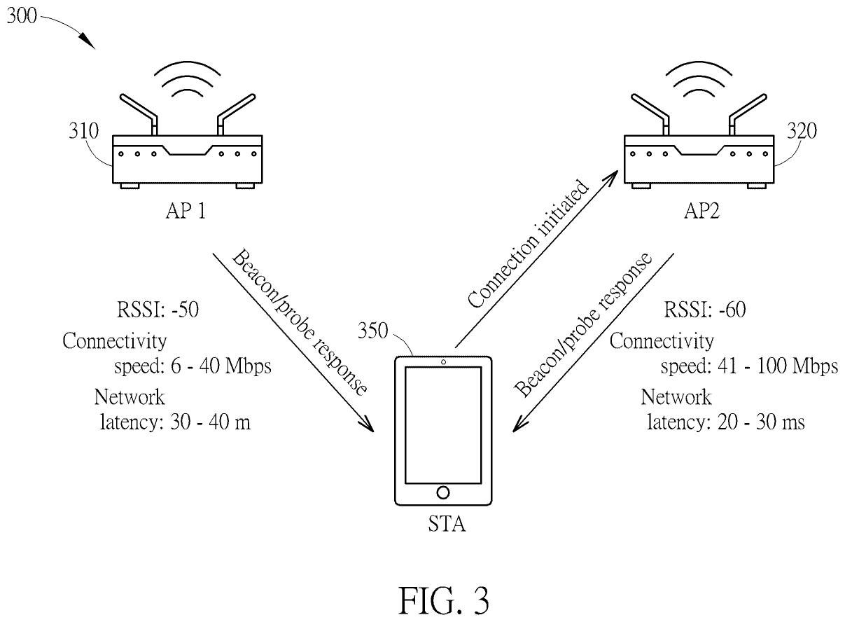

Refer to FIG. 3, which is a diagram of a client device 350 roaming between two APs using the information contained in the extension illustrated in FIG. 2 in order to make the roaming decision. As shown in the diagram, a client device (STA) 350 is roaming within a WLAN 300, and determining whether to connect to a first AP 310 or a second AP 320. As illustrated in FIG. 3, both the first AP 310 and the second AP 320 advertise RSSI, connectivity speed and network latency using the interworking IE as defined in 802.11U and the proposed extension of the present invention. The STA 350 compares all network-related information of the first AP 310 and the second AP 320, and determines to select the AP having the higher connectivity speed and lower latency, such that the STA 350 initiates connection with the second AP 320. Note that, in order for the STA 350 to be able to make this decision, both the first AP 310 and the second AP 320 must enable the extension so that this information is available to the STA 350.

The proposed extension will be included in an interworking IE in beacon frames or probe response frames sent from an AP. When the Internet bit within the Access Network Options in the interworking IE shown in FIG. is set, this indicates that Internet access is enabled; in this case, the connectivity speed indicates the Internet speed. When the Internet bit is not set, i.e. the AP is part of an internal server, the connectivity speed will indicate the backbone speed of the type of network.

Upon initially determining to connect to an AP or when roaming between different APs, the STA can receive information from all APs within a network, and utilize the network-related information in the extension as part of the decision being made for connecting to a specific AP. By increasing the amount of information available to a client device, a more informed decision can be made regarding a network. This makes roaming more efficient. Different configuration options can be enabled by Innovations for High Performance (IHP). Currently, signal strength is the most important decision when determining a candidate AP. By providing the interworking extension, other important network-related information can be part of the network determination.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for an STA to connect with an access point (AP) of a plurality of APs, the method comprising:
the STA performing discovery of the plurality of APs via frame exchange between the STA and the plurality of APs;
the STA determining whether a received frame from each of the plurality of APs comprises an interworking element, wherein the interworking element includes an extension;
when a received frame comprises an interworking element including an extension, accessing the information in the extension;
comparing the information in the extension of each received frame to determine a candidate AP from the plurality of APs; and
initiating connection with said AP to access a network of said AP.

2. The method of claim 1, wherein the frame exchange comprises:
the STA sending a probe request frame to each of the plurality of APs, and receiving a probe response frame from each of the plurality of APs; or
listening for a beacon frame from each of the plurality of APs.

3. The method of claim 1, wherein the information in the extension comprises network latency and connectivity speed.

4. The method of claim 3, wherein the network latency information field comprises a value of a plurality of first values, wherein the plurality of first values are respectively mapped to a plurality of network latency ranges; and the connectivity speed field comprises a value of a plurality of second values, wherein the plurality of second values are respectively mapped to a plurality of connectivity speed ranges.

5. The method of claim 4, wherein the decision to connect with the AP is made automatically by the STA according to profile settings.

6. The method of claim 4, wherein the decision to connect with the AP is made according to a user decision.

7. The method of claim 6, wherein the network latency and connectivity speed is displayed to the user.

8. An extension for an interworking element in a frame sent between an access point (AP) and a client device (STA), comprising:
a network latency information field containing information regarding latency of the AP; and
a connectivity speed information field containing information regarding connectivity speed of the AP.

9. The extension for an interworking element of claim 8, wherein the frame is a beacon frame or a probe response frame sent by the AP to the STA.

10. The extension for an interworking element of claim 8, wherein the network latency field comprises a value of a plurality of first values, wherein the plurality of first values are respectively mapped to a plurality of network latency ranges; and the connectivity speed field comprises a value of a plurality of second values, wherein the plurality of second values are respectively mapped to a plurality of connectivity speed ranges.

11. The extension for an interworking element of claim 10, wherein the extension has a length of one octet, the network latency field comprises four bits and the connectivity speed comprises four bits.
